(19) United States
(12) Patent Application Publication
(10) Pub. No.: US 2025/0280023 A1
(43) Pub. Date: Sep. 4, 2025

(54) DEVICE AND METHOD OF DETERMINING MALICIOUS PACKET IN ENCRYPTED TRAFFIC BASED ON ARTIFICIAL INTELLIGENCE

(71) Applicant: SECURELINK CO., LTD, Seoul (KR)

(72) Inventors: Junyong KO, Gyeonggi-do (KR); Jusun PARK, Seoul (KR)

(21) Appl. No.: 19/208,600

(22) Filed: May 15, 2025

Related U.S. Application Data
(63) Continuation of application No. PCT/KR2022/018036, filed on Nov. 16, 2022.

(30) Foreign Application Priority Data
Nov. 15, 2022 (KR) 10-2022-0152398

(51) Int. Cl. H04L 9/40

(52) U.S. Cl. CPC H04L 63/1425; H04L 63/0236; H04L 63/306

(57) ABSTRACT

A computing device for determining whether a network encrypted traffic includes a malicious packet based on artificial intelligence may comprise at least one processor. A characteristic extraction unit extracting a pre-designated packet and a plurality of fingerprint characteristic values from network encrypted traffic incoming into the computing device implemented by the at least one processor, a meta-characteristic generation unit generating a meta-characteristic for the network encrypted traffic by using a packet and a plurality of fingerprint characteristic values extracted from the characteristic extraction unit to track a change over time of at least one parameter included in the extracted packet, and a determination unit determining whether the network encrypted traffic includes a malicious packet by inputting the plurality of fingerprint characteristic values and the meta-characteristic to a pre-trained artificial neural network may be comprised.

### CROSS-REFERENCE TO RELATED APPLICATION

This application is a US Bypass Continuation application of International Application No. PCT/KR2022/018036, filed on Nov. 16, 2022, which claims priority to and the benefit of Korean Patent Application No. 10-2022-0152398, filed on Nov. 15, 2022, the disclosure of which is incorporated herein by reference in its entirety.

### BACKGROUND

### Technical Field

The present invention relates to a device and method for determining whether an encrypted traffic includes a malicious packet based on artificial intelligence, and more specifically, to a device and method for determining whether a network traffic includes a malicious packet by using high-dimensional characteristics of a network.

### Background Art

As announced by professional organizations that ransomware attacks occur approximately once every two seconds globally, attacks on public social infrastructure and supply chains using major ransomware have recently increased. In the United States and Canada, for example, oil supply chains have been attacked, causing significant damage to numerous companies, facilities, and the daily lives of ordinary people.

Additionally, the combination of ransomware and APT hacking techniques has resulted in greater damage. In domestic cases, critical weapon system information has been leaked from defense industry-related research institutes and technology companies, and privacy violations have increased due to the hacking of apartment wall pads integrated with smart city technology.

Moreover, as hacking methods and techniques targeting almost all fields, including hospitals, companies' critical information, individuals' personal information, and public networks, become more sophisticated and advanced, technologies to block such threats at endpoints (PCs and devices) are being developed. In particular, network detection technologies (NDR), IPS, and next-generation UTM, which aim to detect malicious codes embedded in network packets, are being researched and developed in conjunction with artificial intelligence technologies.

However, an increasing number of malicious codes are being transmitted through secure channels such as SSL/TLS. As a result, the malicious codes targeted for detection by artificial intelligence and other technologies are increasingly being delivered in encrypted forms. Statistically, there was an increase of over 260% in 2017 compared to 2016.

In particular, hackers are exploiting SSL/TLS encrypted traffic technology, which was originally developed to protect packet information transmitted over networks. This makes it difficult to detect and block malicious traffic in the network flow state before decryption at the endpoint or network receiver. Therefore, there is a need to develop technology capable of detecting malicious traffic without decrypting SSL/TLS.

In other words, the commercialization of technology capable of detecting malicious traffic without decrypting SSL/TLS can enable the rapid detection and preemptive blocking of malicious traffic before it reaches the endpoints of enterprises, governments, and individuals. It also enhances the possibility of precise analysis and tracking, and through integration with NDR, XDR, EDR, and endpoint security platforms (EPP) such as antivirus software, it can effectively and comprehensively block malicious codes.

### SUMMARY

The technical problem to be solved by the present invention is to overcome the limitations of applying artificial intelligence detection technology or various malicious code detection technologies after visualizing (decrypting) encrypted traffic in a situation where various new/variant malicious codes such as rapidly increasing malware and ransomware are being transmitted and spread through network security channels such as SSL/TLS encrypted traffic. The invention aims to detect whether malicious traffic packets are included quickly and effectively by extracting high-dimensional characteristics of continuous traffic without decrypting the network encrypted traffic.

The problem to be solved by the present invention is not limited to the problems mentioned above, and other problems not mentioned will be clearly understood by those skilled in the art from the following description.

According to embodiments of the present invention for achieving the above-described problem, a computing device for determining whether encrypted traffic includes a malicious packet based on artificial intelligence may comprise at least one processor.

According to one embodiment, the processor may comprise a characteristic extraction unit extracting a pre-designated packet and a plurality of fingerprint characteristic values (fingerprint) from network encrypted traffic incoming into the computing device, a meta-characteristic generation unit generating a meta-characteristic for the network traffic by using a packet and a plurality of fingerprint characteristic values extracted from the characteristic extraction unit to track a change over time of at least one parameter included in the extracted packet, and a determination unit determining whether the network traffic includes a malicious packet by inputting the plurality of fingerprint characteristic values and the meta-characteristic to a pre-trained artificial neural network.

According to one embodiment, the characteristic extraction unit may extract at least a part of an encryption channel protocol, an encryption channel certificate, a source address, a destination address, port information, and header information extracted from a non-encrypted area of the network encrypted traffic or extracted in an encrypted state as the plurality of fingerprint characteristic values.

According to one embodiment, the meta-characteristic generation unit may group a plurality of packets executing one session among pre-stored session lists as one group and generate a change of a parameter associated with a packet accumulated in each group over time as the meta-characteristic.

According to one embodiment, the meta-characteristic generation unit, when a packet and a plurality of fingerprint characteristic values for new network encrypted traffic are delivered from the characteristic extraction unit, may allocate the packet to at least one of pre-designated groups according to whether there is a same packet or a same session for a packet included in the new network traffic from a pre-designated memory area.

According to one embodiment, the meta-characteristic generation unit may use, as a parameter associated with the packet, at least one of a total network arrival time of a packet, a network latency, a transmission/reception pattern of network traffic including a packet, BPS (Bit per second), PPS (Packet per second), a connection time between packets, the number of sessions per unit time, the number of users per unit time, and an estimated destination hit of a packet.

According to one embodiment, the determination unit, when it is determined that a first network encrypted traffic includes a malicious packet, may asynchronously update a packet or a plurality of fingerprint characteristic values associated with the first network encrypted traffic to a packet classification filter for a malicious packet, and when a packet and a plurality of fingerprint characteristic values for a second network encrypted traffic are delivered from the characteristic extraction unit, may determine whether to block the second network encrypted traffic through the packet classification filter.

According to one embodiment, a method performed by a computing device and determining whether a malicious packet is included based on artificial intelligence may comprise extracting a pre-designated packet and a plurality of fingerprint characteristic values (fingerprint) from network encrypted traffic, generating a meta-characteristic for the network traffic by using an extracted packet and a plurality of fingerprint characteristic values to track a change over time of at least one parameter included in the extracted packet, and determining whether the network encrypted traffic includes a malicious packet by inputting the plurality of fingerprint characteristic values and the meta-characteristic to a pre-trained artificial neural network.

According to one embodiment, the step of extracting a pre-designated packet and a plurality of fingerprint characteristic values (fingerprint) may comprise extracting at least a part of an encryption channel protocol, an encryption channel certificate, a source address, a destination address, port information, and header information extracted from a non-encrypted area of the network encrypted traffic or extracted in an encrypted state as the plurality of fingerprint characteristic values.

According to one embodiment, the step of generating a meta-characteristic may comprise grouping a plurality of packets executing one session among pre-stored session lists as one group and generating a change of a parameter associated with a packet accumulated in each group over time as the meta-characteristic.

According to one embodiment, the step of generating a meta-characteristic may further comprise, when a packet and a plurality of fingerprint characteristic values for new network traffic are delivered from the characteristic extraction unit, allocating the packet to at least one of pre-designated groups according to whether there is a same packet or a same session for a packet included in the new network traffic from a pre-designated memory area.

According to one embodiment, a parameter associated with the packet may comprise at least one of a total network arrival time of a packet, a network latency, a transmission/reception pattern of network traffic including the packet, BPS (Bit per second), PPS (Packet per second), a connection time between packets, the number of sessions per unit time, the number of users per unit time, and an estimated destination hit of a packet.

According to one embodiment, the step of determining whether the network encrypted traffic includes a malicious packet may further comprise, when it is determined that a first network encrypted traffic includes a malicious packet, asynchronously updating a packet or a plurality of fingerprint characteristic values associated with the first network encrypted traffic to a packet classification filter for a malicious packet, and when a packet and a plurality of fingerprint characteristic values (fingerprint) for a second network encrypted traffic are delivered from the characteristic extraction unit, performing whether to block the second network encrypted traffic through the packet classification filter.

According to the embodiments of the present invention, it is possible to rapidly detect malicious packets, which include malicious codes, ransomware, and various mutated malicious codes that are being distributed within the explosively increasing encrypted traffic on secure channels, without requiring complex configurations of resources and infrastructure for decrypting packets within the traffic.

Through the present invention, it is possible to complement the vulnerable security environments of small and medium-sized enterprises, small business owners, and individual users who are exposed to damages caused by malicious codes such as ransomware, and to provide the effect of detecting and blocking malicious codes in advance at the network level without significant financial investment.

In addition, in the configuration of converged security models such as EDR and NDR, it is possible to quickly and preemptively specify and reduce the scope and targets that need to be detected and blocked, enabling a more accurate and selective concentration of resources for a robust response.

Furthermore, in the domestic firewall and network market, which is worth approximately 200 billion KRW, the present invention can significantly contribute to cost reduction and the expansion of new technologies through innovations in the firewall and UTM market, which serve as critical security measures for small and medium-sized enterprises.

### BRIEF DESCRIPTION OF THE DRAWINGS

FIG. 1 is a block diagram of a computing device performing a method for determining whether a malicious packet is included according to an embodiment.

FIG. 2 is an exemplary diagram for explaining an encrypted traffic fingerprint and meta-characteristic according to an embodiment.

FIG. 3 is an exemplary diagram for explaining an operation of detecting malicious encrypted traffic according to an embodiment.

FIG. 4 is an exemplary diagram for explaining an operation interworking with an endpoint terminal device according to an embodiment.

FIG. 5 is an exemplary diagram for explaining an operation interworking with cloud equipment according to an embodiment.

FIG. 6 is a flowchart for explaining a method for determining whether a malicious packet is included according to an embodiment.

FIG. 7 is a flowchart for explaining a method for determining whether a malicious packet is included by interworking with an endpoint terminal device according to an embodiment.

FIG. 8 is a flowchart for explaining a method for determining whether a malicious packet is included by interworking with cloud equipment according to an embodiment.

### DETAILED DESCRIPTION

Hereinafter, embodiments of the present invention will be described in detail with reference to the accompanying drawings.

The embodiments of the present invention described below are provided to more clearly explain the present invention to those skilled in the art, and the scope of the present invention is not limited by the following embodiments, and the following embodiments may be modified in various other forms.

The terms used in this specification are used to describe specific embodiments and are not intended to limit the present invention. The singular forms used in this specification may include plural forms unless the context clearly indicates otherwise. In addition, the terms “comprise” and/or “comprising” used in this specification specify the presence of stated shapes, steps, numbers, operations, members, elements, and/or groups thereof, and do not exclude the presence or addition of one or more other shapes, steps, numbers, operations, members, elements, and/or groups thereof. Furthermore, the term “connection” used in this specification not only means that certain members are directly connected but also includes the concept of being indirectly connected with other members interposed between the members.

Moreover, when it is stated in this specification that a certain member is located “on” another member, this includes not only the case where a certain member is in contact with another member but also the case where another member exists between the two members. The term “and/or” used in this specification includes any one and all combinations of the listed items. In addition, the terms such as “about” and “substantially” used in this specification are used in the sense of encompassing the range or proximity of the numerical value or degree in consideration of inherent manufacturing and material tolerances, and are used to prevent an infringer from unfairly exploiting the disclosed content where exact or absolute numerical values are provided to aid understanding of the present invention.

Hereinafter, embodiments of the present invention will be described in detail with reference to the accompanying drawings. The sizes or thicknesses of the areas or parts shown in the accompanying drawings may be somewhat exaggerated for clarity and convenience of explanation in the specification. Throughout the detailed description, the same reference numerals denote the same components.

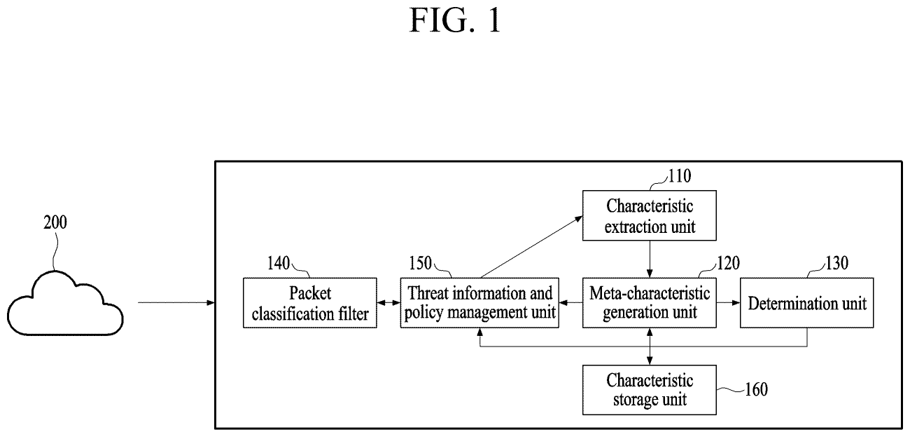

FIG. 1 is a block diagram of a computing device performing a method for determining whether a malicious packet is included according to an embodiment.

Referring to FIG. 1, a computing device for determining whether a malicious packet is included based on artificial intelligence may comprise at least one processor 100. According to an embodiment, the processor 100 may implement a characteristic extraction unit 110, a meta-characteristic generation unit 120, and a determination unit 130.

According to an embodiment, the characteristic extraction unit 110 may extract a pre-designated packet and a plurality of fingerprint characteristic values from network encrypted traffic incoming into the computing device. The characteristic extraction unit 110 may extract at least a part of an encryption channel protocol, an encryption channel certificate, a source address, a destination address, port information, and header information extracted from a non-encrypted area of the network traffic or extracted in an encrypted state as the plurality of fingerprint characteristic values. The characteristic extraction unit 110 may extract fingerprint characteristic values from a non-encrypted area of the network traffic without a decryption process.

According to an embodiment, the characteristic extraction unit 110 may extract fingerprint characteristic values without a decryption process, enabling rapid detection of packets in traffic containing malicious codes, ransomware, and various variants of malicious codes without requiring complex configurations of resources and infrastructure for decryption of the packets. That is, the computing device according to the present invention may complement the vulnerable security environments of small and medium-sized enterprises, small business owners, and individual users exposed to damage from malicious codes such as ransomware, and provide an effect of pre-detecting and blocking malicious codes at the network level without significant cost investment. Accordingly, in constructing convergence security models such as EDR and NDR, it may be possible to quickly specify and reduce the range and target to be detected and blocked in advance, enabling more accurate and selective resource concentration for a strong response.

According to an embodiment, the meta-characteristic generation unit 120 may generate a meta-characteristic for the network traffic by using a packet and a plurality of fingerprint characteristic values extracted from the characteristic extraction unit 110 to track a change over time of at least one parameter included in the extracted packet. That is, the meta-characteristic generation unit 120 may query preceding packets in the same session or traffic to generate high-dimensional meta-characteristics for the packet delivered from the characteristic extraction unit 110.

According to an embodiment, the meta-characteristic generation unit 120 may group a plurality of packets executing one session among pre-stored session lists as one group and generate a change of a parameter associated with a packet accumulated in each group over time as the meta-characteristic.

According to an embodiment, the meta-characteristic generation unit 120 may, when a packet and a plurality of fingerprint characteristic values for new network traffic are delivered from the characteristic extraction unit, allocate the packet to at least one of pre-designated groups according to whether there is a same packet or a same session for a packet included in the new network traffic from a pre-designated memory area.

According to an embodiment, the meta-characteristic generation unit 120 may use, as a parameter associated with the packet, at least one of a total network arrival time of a packet, a network latency, a transmission/reception pattern of network traffic including a packet, BPS (Bit per second), PPS (Packet per second), a connection time between packets, the number of sessions per unit time, the number of users per unit time, and an estimated destination hit of a packet.

According to an embodiment, the determination unit 130 may determine whether the network traffic includes a malicious packet by inputting the plurality of fingerprint characteristic values and the meta-characteristic to a pre-trained artificial neural network. That is, the determination unit 130 may be requested by the meta-characteristic generation unit 120 to determine whether it is malicious.

According to an embodiment, the determination unit 130 may combine and learn fingerprints and meta-characteristics based on a large-scale data classification model and deep learning models such as RNN and CNN, determine whether it is malicious based on the requested characteristics, and provide the determination result to a threat information and policy management unit 150.

According to an embodiment, the determination unit 130 may, when it is determined that a first network encrypted traffic includes a malicious packet, asynchronously update a packet or a plurality of fingerprint characteristic values associated with the first network traffic to a packet classification filter 140 for a malicious code. The determination unit 130 may, when a packet and a plurality of fingerprint characteristic values for a second network encrypted traffic are delivered from the characteristic extraction unit, perform whether to block the second network traffic through the packet classification filter 140.

According to an embodiment, the packet classification filter 140 may separate the protocol of a packet for network encrypted traffic packets incoming from an external network such as a WAN or another network and store the packet corresponding to the security channel for later use.

According to one embodiment, when the determination unit 130 determines that the first network traffic includes a malicious packet, the packet classification filter 140 may asynchronously update packets or a plurality of fingerprint characteristic values associated with the first network encrypted traffic. Additionally, the packet classification filter 140 may perform blocking of the second network encrypted traffic when packets and a plurality of fingerprint characteristic values (fingerprint) for the second network encrypted traffic are delivered from the characteristic extraction unit.

According to one embodiment, the threat information and policy management unit 150 may request artificial intelligence determination for the relevant packet and respond with whether the pre-determined packet is malicious, and provide the response result to other security devices.

According to one embodiment, the characteristic storage unit 160 may store the relevant packet information to extract additional high-dimensional characteristics if there is no stored preceding packet information.

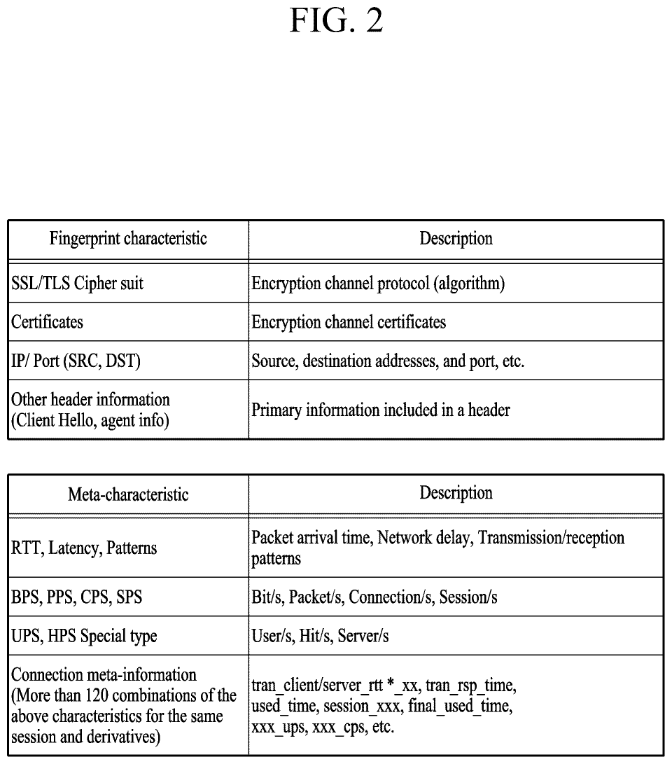

FIG. 2 is an exemplary diagram for explaining encrypted traffic fingerprints and meta-characteristics according to one embodiment.

Referring to FIG. 2, information on respective fingerprint characteristic values and meta-characteristics can be identified. For example, SSL/TLS Cipher suite may refer to an encryption channel protocol (algorithm). Certificates may refer to encryption channel certificates. IP/Port (SRC, DST) may refer to source, destination addresses, and ports. Other header information such as Client Hello and agent info may refer to primary information included in the header.

According to one embodiment, meta-characteristics may include RTT, which refers to packet arrival time, Latency, which refers to network delay, and Pattern, which refers to transmission/reception patterns. BPS refers to Bit per second, PPS refers to Packet per second, CPS refers to connection time between packets, SPS refers to the number of sessions per unit time, UPS refers to the number of users per unit time, and HPS refers to the estimated destination hit of a packet. Additionally, connection meta-information may include tran_client/server_rtt*_xx, tran_rsp_time, used_time, session_xxx, final_used_time, xxx_ups, xxx_cps, and others.

That is, the meta-characteristic generation unit 120 may select RTT (total network arrival time of the relevant packet), network delay time (Latency), transmission/reception patterns of traffic including the relevant packet, BPS (Bit/s), PPS (Packet/s), connection time between packets (Connection/s), sessions (Sessions/s), user information (User/s) that can be estimated and extracted through associated information between traffic packet fingerprint information and response packets, and the estimated destination hit rate of a packet (Hits/s). The meta-characteristic generation unit 120 may generate various final meta-characteristics by cross-combining the generated characteristics with source and destination information.

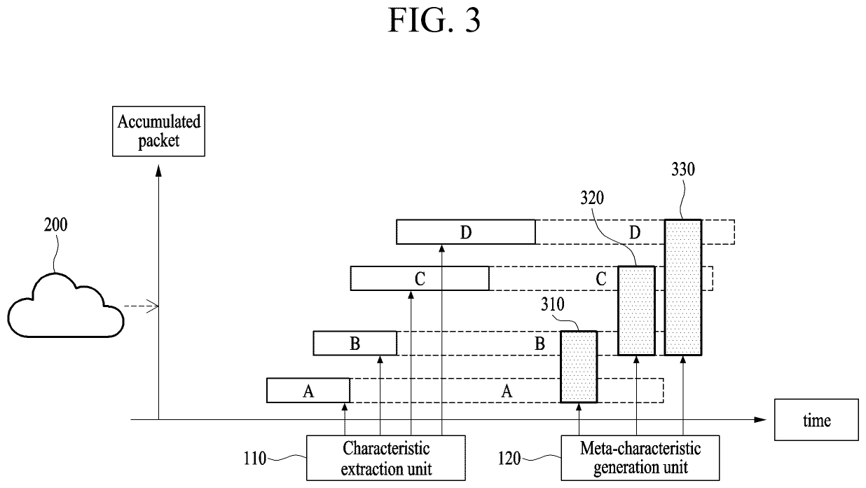

FIG. 3 is an exemplary diagram for explaining an operation of detecting malicious encrypted traffic according to one embodiment.

Referring to FIG. 3, the characteristic extraction unit 110 may define fingerprint characteristics in advance (A, B, C, D) and individually extract fingerprint characteristic values for each requested packet accordingly. After the characteristic extraction unit 110 extracts fingerprint characteristic values, it may deliver the characteristics along with packet information to the meta-characteristic generation unit 120 to generate more advanced meta-characteristics.

The meta-characteristic generation unit 120 may group a plurality of packets executing one session among pre-stored session lists as one group and generate changes in parameters associated with packets accumulated in each group (310, 320, 330) over time as the meta-characteristics.

The meta-characteristic generation unit 120, when packets and a plurality of fingerprint characteristic values for new network encrypted traffic are delivered from the characteristic extraction unit 110, may allocate the packets to at least one of pre-designated groups (310, 320, 330) according to whether the same packet or the same session for packets included in the new network traffic exists in the characteristic storage unit 160. For example, the first group 310 may be defined as a group including packets executing the first session. The first group 310 may group packet A and packet B performing the first session, and although not shown in FIG. 3, packets performing the first session among subsequently delivered packets may be newly allocated to the first group 310. Similarly, the second group 320 may group packets executing the second session, grouping packet B and packet C. Additionally, the third group 330 may group packets executing the third session, grouping packet B, packet C, and packet D. The meta-characteristic generation unit 120 may track changes over time in a plurality of parameters related to each group (310, 320, 330) and generate them as meta-characteristics.

According to one embodiment, the meta-characteristic generation unit 120 may query the characteristic storage unit 160 to check whether associated packets stored previously exist based on the requested packets and characteristics.

That is, the meta-characteristic generation unit 120 may define meta-characteristics in advance and generate individual combinations for packets associated with the requested packets accordingly. If there are no associated packets or characteristics for the relevant packets, the meta-characteristic generation unit 120 may store the relevant packets and characteristics in the characteristic storage unit 160 and respond to the threat information and policy management unit 150 with a result indicating that additional characteristic information is required for the relevant packets.

According to another embodiment, the characteristic extraction unit 110 may combine related packet information stored in the characteristic storage unit 160 and extract additional advanced characteristics based on time and related information if related packets are stored.

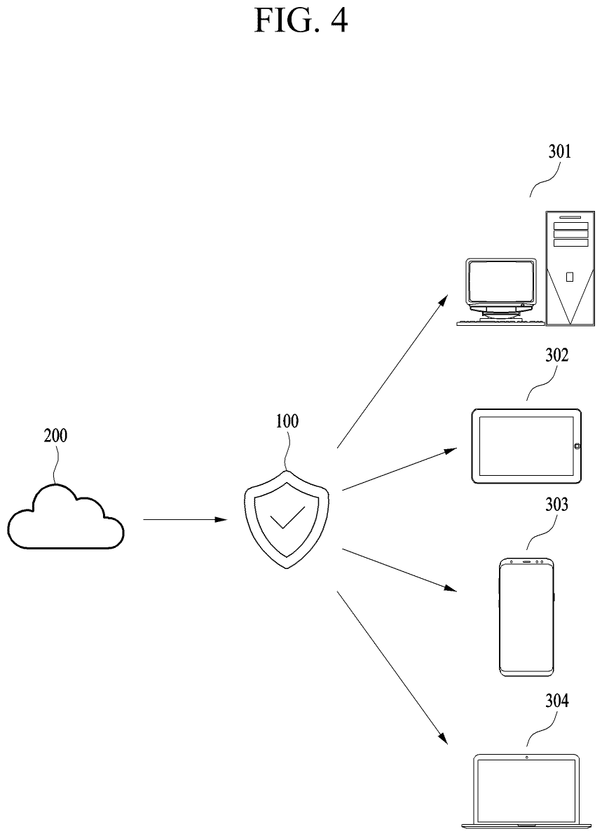

FIG. 4 is an exemplary diagram for explaining an operation interworking with endpoint terminal equipment according to one embodiment.

Referring to FIG. 4, the processor according to the present invention may be mounted on various security devices and network devices such as a firewall (FW), UTM, intrusion prevention system (IPS), and next-generation network detection (NDR). At this time, the security management unit operating on various terminal devices such as external PCs, mobile devices, and IoT devices may provide information on whether malicious detection is performed for site access information of users and devices, allowing the security management unit of the relevant device to block access to the relevant site and remote access in advance or block the execution of downloaded files.

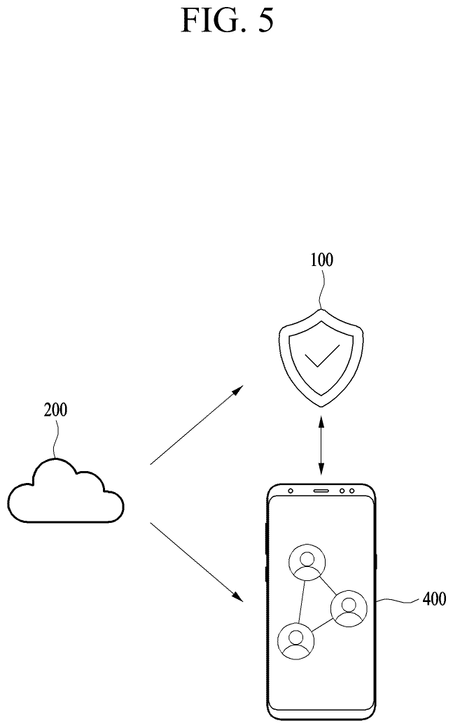

FIG. 5 is an exemplary diagram for explaining an operation interworking with cloud equipment according to one embodiment.

Referring to FIG. 5, the processor according to the present invention may be mounted on various security devices and network devices such as a firewall (FW), UTM, intrusion prevention system (IPS), and next-generation network detection (NDR). At this time, it may share packets and learning information with a security management unit built in an external network environment such as an external cloud. This result may be provided to external threat information sharing (CTI) and cloud software rental system (SaaS) equipment to determine and process whether the relevant packet is malicious.

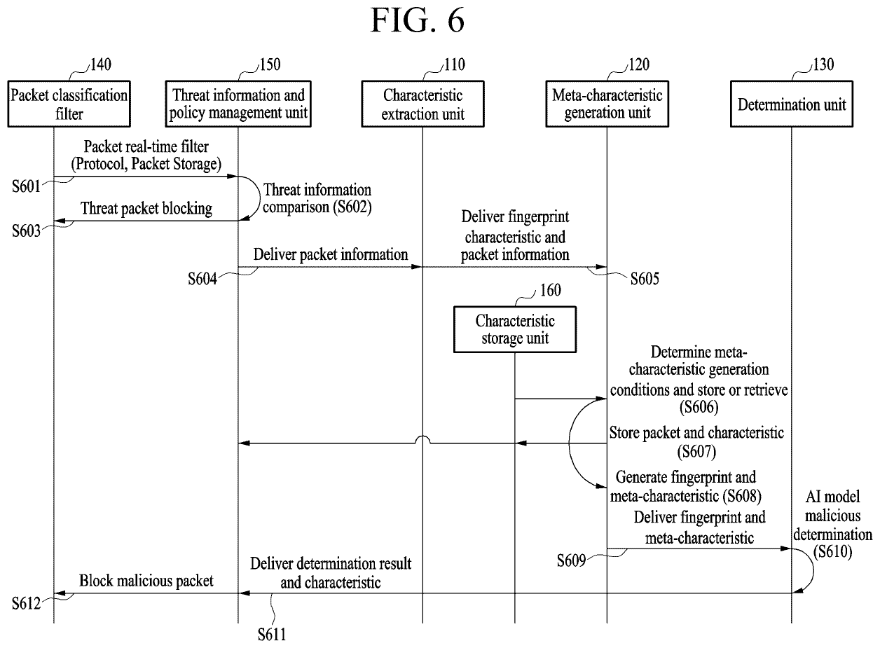

FIG. 6 is a flowchart for explaining a method of determining whether a malicious packet is included according to one embodiment.

Referring to FIG. 6, the packet classification filter 140 may classify protocols from incoming network traffic packets and transmit packets corresponding to security channels to the threat information and policy management unit 150 (S601). The classified packets may be used for subsequent audits and warning processing and may be stored for asynchronous mirroring configurations depending on the network configuration.

According to one embodiment, the threat information and policy management unit 150 may query whether pre-detection results exist for the same packet through fingerprint information of the requested packet (S602). According to one embodiment, the threat information and policy management unit 150 may respond with the result if it exists.

According to one embodiment, the packet classification filter 140 can identify a packet through fingerprint characteristic values and block the packet if there is existing detection determination information (S603).

According to one embodiment, the threat information and policy management unit 150 can deliver the packet information to the characteristic extraction unit 110 to extract primary characteristics such as fingerprints if there is no existing determination information (S604).

According to one embodiment, the characteristic extraction unit 110 can deliver the fingerprint characteristic values along with the packet information to the meta-characteristic generation unit 120 to generate more advanced meta-characteristics after extracting the fingerprint characteristic values (S605).

According to one embodiment, the meta-characteristic generation unit 120 can determine the meta-characteristic generation conditions and store or retrieve the meta-characteristics accordingly (S606).

According to one embodiment, the meta-characteristic generation unit 120 can query the characteristic storage unit 160 to check whether associated packets stored previously exist based on the requested packet and fingerprint characteristic values. The meta-characteristic generation unit 120 can generate individual combinations for packets associated with the requested packet. If there are no associated packets and characteristics related to the packet, the packet and its characteristics can be stored in the characteristic storage unit 160 (S607). If additional characteristic information is required for the packet, the undetected result can be sent back to the threat information and policy management unit 150, and the process can terminate.

According to one embodiment, if related packets are stored in the characteristic storage unit 160, the related packet information can be combined to extract additional time and related advanced characteristics. According to one embodiment, the characteristic storage unit 160 can allow the meta-characteristic generation unit 120 to query previously stored packets in an accumulated state when generating meta-characteristics. The characteristic storage unit 160 can extract and calculate interrelated information from the accumulated packet information and combine and store advanced characteristics.

According to one embodiment, the determination unit 130 can receive the fingerprint characteristic values and the generated meta-characteristics (S609). The determination unit 130 can generate and reference classification indicators clustered into a large-scale classification model without labeling based on pre-collected and labeled large-scale general and malicious traffic packet data and fingerprint characteristic values. The determination unit 130 can generate the determination result of the artificial neural network for the requested characteristics through a deep learning model (RNN, CNN) optimized with various hyperparameters and detailed modules using the fingerprint characteristic values and meta-characteristics (S610).

According to one embodiment, the determination unit 130 can transmit the output result of the artificial neural network to the threat information and policy management unit 150 (S611). Specifically, the threat information and policy management unit 150 can receive and store the determination result transmitted from the determination unit 130 and configure the information according to a threat information sharing (CTI) protocol to provide it externally.

Finally, the packet classification filter 140 can block the packet synchronously or transmit and store the results in security systems, databases, etc., based on the determination result of the packet transmitted by the threat information and policy management unit 150 (S612).

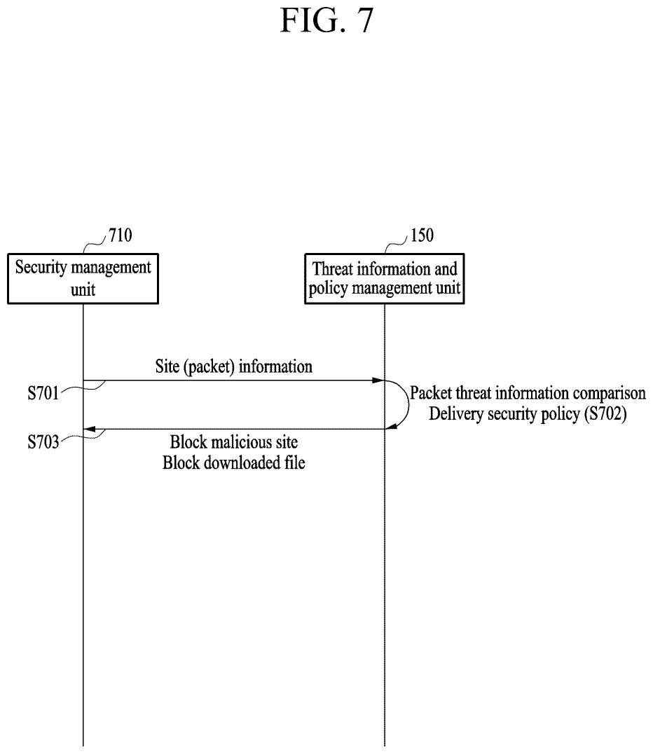

FIG. 7 is a flowchart illustrating a method for determining whether a malicious packet is included by interworking with an endpoint terminal device according to one embodiment.

Referring to FIG. 7, the security management unit 710 included in the endpoint terminal device can transmit site information packets or packet information containing specific fingerprint characteristics accessed by the terminal device to the threat information and policy management unit 150 (S701).

According to one embodiment, the threat information and policy management unit 150 can query the unique fingerprint characteristic information of the packet from previously detected results and reply with the result in a format such as STIX or JSON according to a threat information sharing (CTI) protocol (S702).

According to one embodiment, the security management unit 710 can block the site being accessed and block the execution of payloads downloaded from the site based on the reply result in step (S720) (S703).

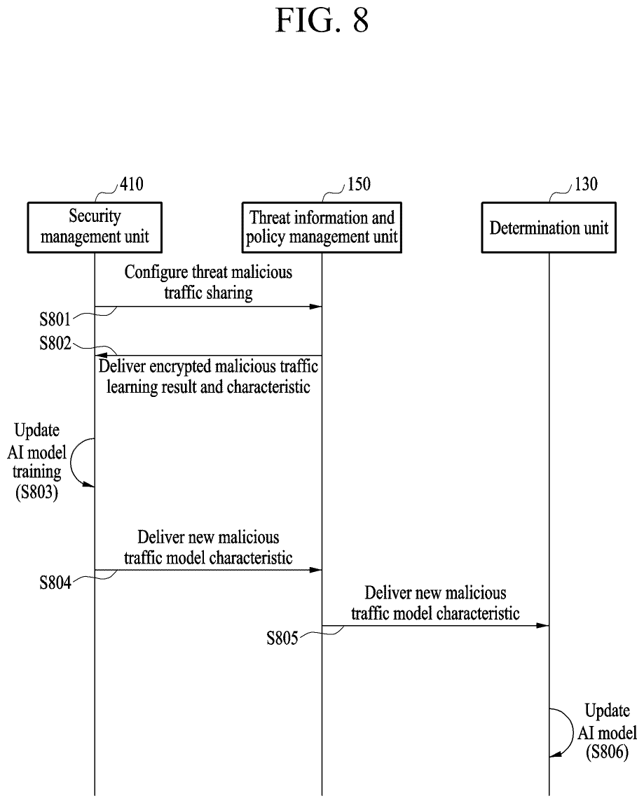

FIG. 8 is a flowchart illustrating a method for determining whether a malicious packet is included by interworking with external cloud equipment and a network according to one embodiment.

Referring to FIG. 8, the security management unit 410 included in the external cloud equipment and network can be pre-configured to share threat traffic detection results with the threat information and policy management unit 150 (S801).

According to one embodiment, the threat information and policy management unit 150 can deliver the packet and characteristic information and results to the shared security management unit 410 when new learning results are generated (S802). The security management unit 410 can enhance its own artificial intelligence learning model using the information (S803).

Additionally, for malicious encrypted traffic packets detected in the external network and cloud, the security management unit 410 can deliver the extracted characteristics and learning results to the threat information and policy management unit 150 (S804).

According to one embodiment, the threat information and policy management unit 150 can deliver the received characteristics and learning results in step (S840) to the determination unit 130 (S805). Based on the received characteristics and learning results, the determination unit 130 can reinforce the artificial neural network through reinforcement learning (S806).

In this specification, preferred embodiments of the present invention have been disclosed, and although specific terms have been used, they are used in a general sense to easily explain the technical content of the present invention and to aid understanding of the invention, not to limit the scope of the present invention. It is apparent to those skilled in the art that other modifications based on the technical spirit of the present invention can be implemented in addition to the embodiments disclosed herein. For example, those skilled in the art can understand that the method for determining whether a malicious packet is included in encrypted traffic based on artificial intelligence according to the embodiments described with reference to FIGS. 1 to 8 can be variously modified. Therefore, the scope of the invention should not be determined by the described embodiments but should be determined by the technical spirit described in the claims.

What is claimed is:

1. A computing device for determining whether a network encrypted traffic includes a malicious packet based on artificial intelligence, comprising at least one processor, and implemented by the at least one processor:
a characteristic extraction unit extracting a pre-designated packet and a plurality of fingerprint characteristic values from network traffic incoming into the computing device;
a meta-characteristic generation unit generating a meta-characteristic for the network traffic by using a packet and a plurality of fingerprint characteristic values extracted from the characteristic extraction unit to track a change over time of at least one parameter included in the extracted packet; and
a determination unit determining whether the network traffic includes a malicious packet by inputting the plurality of fingerprint characteristic values and the meta-characteristic to a pre-trained artificial neural network.

2. The computing device of claim 1, wherein the characteristic extraction unit extracts at least a part of an encryption channel protocol, an encryption channel certificate, a source address, a destination address, port information, and header information extracted from a non-encrypted area of the network traffic or extracted in an encrypted state as the plurality of fingerprint characteristic values.

3. The computing device of claim 1, wherein the meta-characteristic generation unit groups a plurality of packets executing one session among pre-stored session lists as one group, and generates a change of a parameter associated with a packet accumulated in each group over time as the meta-characteristic.

4. The computing device of claim 3, wherein the meta-characteristic generation unit, when a packet and a plurality of fingerprint characteristic values for a new network traffic are delivered from the characteristic extraction unit, allocates the packet to at least one of pre-designated groups according to whether there is a same packet or a same session for a packet included in the new network traffic from a pre-designated memory area.

5. The computing device of claim 3, wherein the meta-characteristic generation unit uses, as a parameter associated with the packet, at least one of a total network arrival time of a packet, a network latency, a transmission/reception pattern of network traffic including a packet, BPS (Bit per second), PPS (Packet per second), a connection time between packets, the number of sessions per unit time, the number of users per unit time, and an estimated destination hit of a packet.

6. The computing device of claim 1, wherein the determination unit, when it is determined that a first network traffic includes a malicious packet, asynchronously updates a packet or a plurality of fingerprint characteristic values associated with the first network traffic to a packet classification filter for a malicious packet, and
when a packet and a plurality of fingerprint characteristic values for a second network traffic are delivered from the characteristic extraction unit, determines whether to block the second network traffic through the packet classification filter.

7. A method performed by a computing device and determining whether a network encrypted traffic includes a malicious packet based on artificial intelligence, comprising:
extracting a pre-designated packet and a plurality of fingerprint characteristic values from network traffic;
generating a meta-characteristic for the network traffic by using an extracted packet and a plurality of fingerprint characteristic values to track a change over time of at least one parameter included in the extracted packet; and
determining whether the network traffic includes a malicious packet by inputting the plurality of fingerprint characteristic values and the meta-characteristic to a pre-trained artificial neural network.

8. The method of determining whether a malicious packet is included based on artificial intelligence of claim 7, wherein the extracting a pre-designated packet and a plurality of fingerprint characteristic values comprises:
extracting at least a part of an encryption channel protocol, an encryption channel certificate, a source address, a destination address, port information, and header information extracted from a non-encrypted area of the network traffic or extracted in an encrypted state as the plurality of fingerprint characteristic values.

9. The method of determining whether a malicious packet is included based on artificial intelligence of claim 7, wherein the generating a meta-characteristic comprises:
grouping a plurality of packets executing one session among pre-stored session lists as one group; and
generating a change of a parameter associated with a packet accumulated in each group over time as the meta-characteristic.

10. The method of determining whether a malicious packet is included based on artificial intelligence of claim 8, wherein the generating a meta-characteristic further comprises:
when a packet and a plurality of fingerprint characteristic values for a new network traffic are delivered from a characteristic extraction unit, allocating the packet to at least one of pre-designated groups according to whether there is a same packet or a same session for a packet included in the new network traffic from a pre-designated memory area.

11. The method of determining whether a malicious packet is included based on artificial intelligence of claim 8, wherein a parameter associated with the packet comprises at least one of a total network arrival time of a packet, a network latency, a transmission/reception pattern of network traffic including the packet, BPS (Bit per second), PPS (Packet per second), a connection time between packets, the number of sessions per unit time, the number of users per unit time, and an estimated destination hit of a packet.

12. The method of determining whether a malicious packet is included based on artificial intelligence of claim 7, wherein the determining whether the network encrypted traffic includes a malicious packet further comprises:
when it is determined that a first network traffic includes a malicious packet, asynchronously updating a packet or a plurality of fingerprint characteristic values associated with the first network encrypted traffic to a packet classification filter for a malicious packet; and
when a packet and a plurality of fingerprint characteristic values for a second network encrypted traffic are delivered from a characteristic extraction unit, performing whether to block the second network encrypted traffic through the packet classification filter.
